(19) United States
(12) Patent Application Publication
(10) Pub. No.: US 2008/0071390 A1
(43) Pub. Date: Mar. 20, 2008

(54) Lighting systems and methods

(76) Inventors: James B. Busby, Mobile, AL (US); James L. Busby, Mobile, AL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/514,357

(22) Filed: Aug. 31, 2006

(51) Int. Cl. G05B 11/01

(52) U.S. Cl. 700/12

(57) ABSTRACT

In general, the present disclosure pertains to systems and methods for controlling the states of lights and/or other electrical components. In one exemplary embodiment, a system employs a centralized base unit that wirelessly communicates with remote switching units, which control various loads, such as lights and/or other electrical components, based on commands from the base unit. One of the switching units has a first user input device and a second user input device. In response to inputs received via the first user input device, the switching unit controls a local load independent of communication with the base unit. However, the switching unit communicates with the base unit to inform it of the current operational state of the local load. The switching unit transmits, to the base unit, messages indicative of inputs received via the second user input device, and these messages may indicate a duration that the second user input device remains continuously activated. The base unit controls at least one remote load based on such messages.

### RELATED ART

Conventional lighting systems are evolving to provide users with greater flexibility in controlling lights in both residential and commercial applications. Intelligence is being programmed into light switches to enable lights to be automatically controlled according to predefined algorithms in response to certain user inputs and/or other types of events. For example, a residential lighting system may be programmed such that every light in a house is turned on in response to a single user input, such as a flip of a light switch or touch of a button. In other examples, only certain lights, such as lights within a particular room or set of rooms, are turned on in response to a particular user input. Further, each light may be respectively set to a predefined dim level. Moreover, a user has the ability to program various lighting scenes and to thereafter easily activate a desired scene.

As used herein, the term “scene” shall be used to refer to a respective lighting state of a lighting system. Further, a particular scene may pertain to every light in the lighting system or may pertain to only some lights. For example, for a first scene, a user may specify that every light in a house is to be on. Thus, if the first scene is activated by the user, then the lighting system ensures that every light in the house is turned on. Such a scene may be specified such that every light is turned on to its full power or such that one or more of the lights are dimmed to a certain percentage of full power or turned off completely. Another scene may pertain to only the lights in a particular room or set of rooms. If a scene does not pertain to a given light, then the lighting system typically does not change the state of such light when the scene is activated. Moreover, the user has the flexibility to define various numbers of scenes to control the lights within a lighting system in various manners.

A given light switch typically controls only one light or a small number of lights usually within a local area. However, a scene may pertain to various lights that operate under the control of different switches. Current lighting systems employ a centralized base unit that is used to communicate with the light switches and control the manner that each switch activates its respective light or lights. Thus, when a user submits an input for activating a desired scene, the input is communicated to the base unit, and the base unit then communicates with each light switch that controls at least one light pertaining to the requested scene. In this regard, each such light switch, based on instructions from the base unit, controls its respective light or lights such that the requested scene is implemented by the lighting system.

In some centralized lighting systems, a building or other structure is wired or re-wired such that the base unit is electrically connected to each light switch. However, the process of installing such wiring can be expensive. As an alternative, wireless communication devices can be installed at each switch and the base unit to provide wireless communication links between the base unit and the light switches. However, utilizing wireless communication between the switches and base unit can make the communication and control of the switches more complex.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating a lighting system in accordance with an exemplary embodiment of the present disclosure.

FIG. 2 is a block diagram illustrating an exemplary embodiment of a base unit depicted in FIG. 1.

FIG. 3 is a block diagram illustrating an exemplary embodiment of the base unit depicted in FIG. 2.

FIG. 4 is a block diagram illustrating an exemplary embodiment of a switching unit depicted in FIG. 1.

FIG. 5 is a block diagram illustrating an exemplary embodiment of a switch interface depicted in FIG. 4.

FIG. 6 is a block diagram illustrating an exemplary embodiment of the switching unit depicted in FIG. 4.

FIG. 7 is a flow chart illustrating an exemplary functionality of the switching unit of FIG. 4 in responding to commands entered via a button depicted in FIG. 5.

FIG. 8 is a flow chart illustrating an exemplary functionality of the base unit of FIG. 3.

FIG. 9 is a block diagram illustrating an exemplary house that employs the lighting system of FIG. 1.

FIG. 10 is a flow chart illustrating an exemplary functionality of the switching unit of FIG. 4 in responding to command entered via at least one button depicted in FIG. 5.

FIG. 11 is a flow chart illustrating an exemplary functionality of the switching unit of FIG. 4 in responding to base unit commands.

FIG. 12 is a block diagram illustrating exemplary scene data depicted in FIG. 6.

FIG. 13 is a block diagram illustrating exemplary scene data depicted in FIG. 6.

### DETAILED DESCRIPTION

In general, the present disclosure pertains to systems and methods for controlling the states of lights and/or other electrical (e.g., electronic) components. In accordance with one exemplary embodiment of the present disclosure, a system employs a centralized base unit that wirelessly communicates with remote switching units, which control various loads, such as lights and/or other electrical components, based on commands from the base unit.

In at least some embodiments, one of the switching units has at least a first user input device and a second user input device. In response to inputs received via the first user input device, the switching unit controls a local load independent of communication with the base unit. However, the switching unit communicates with the base unit to inform it of the current operational state of the local load. The switching unit transmits, to the base unit, messages indicative of inputs received via the second user input device, and the base unit controls at least one remote load based on such messages. The messages may indicate a duration that the second user input device remains continuously activated, and the base unit may control at least one of the remote loads based on such duration.

Further, in at least some embodiments, a user can program various scenes for various loads and then implement a desired scene by providing an input to the base unit or the switching units. In response to the input, the base unit communicates with the switching units such that those switching units affected by the desired scene change the states of their loads, if necessary, to comport with the desired scene.

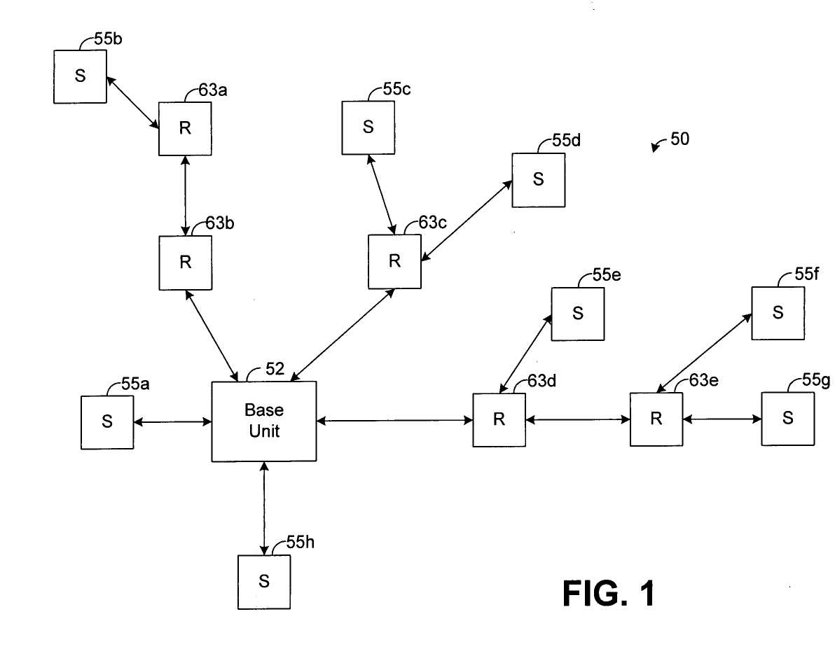

FIG. 1 depicts a lighting system 50 in accordance with an exemplary embodiment of the present disclosure. As shown by FIG. 1, the system 50 comprises a base unit 52 and a plurality of switching units (“S”) 55a-h. As will be described in more detail hereafter, each switching unit 55a-h is electrically connected to and controls the activation state of at least one load. Each load can comprise a light source, such as a light bulb or light emitting diode (LED), and/or another type of electrical component, such as a household appliance (e.g., television, movie projector, stove, etc.). For the purposes of illustration, it will be assumed hereafter that each load comprises at least one light source. However, it should be emphasized that a load can comprise any type of electrical component in addition to or in lieu of the light sources described herein.

In one exemplary embodiment, the base unit 52 communicates with switching units 55a-h via wireless signals, such as radio frequency (RF) signals. Depending on the transmission power of such signals and the distance between a respective switching unit 55a-h and the base unit 52, it may be desirable to employ one or more repeaters. For example, FIG. 1 depicts five repeaters 63a-e, although any number of repeaters may be used in other examples.

In particular, the base unit 52 comminutes with the switching unit 55b through repeaters 63a and 63b. In this regard, a wireless signal destined for the switching unit 55b is received by the repeater 63b, which regenerates the signal and wirelessly transmits a regenerated signal representative of the original wireless signal transmitted by the base unit 52. The repeater 63a receives the regenerated signal and regenerates this signal to define yet another regenerated signal, which is wirelessly transmitted by the repeater 63a. The switching unit 55b receives the regenerated signal transmitted by the repeater 63a, and this received signal is representative of the original wireless signal transmitted by base unit 52.

Further, the switching unit 55b may transmit wireless signals in the reverse direction of the foregoing communication path to communicate information to the base unit 55h. Moreover, the use of the repeaters 63a and 63b allows the switching unit 55b to be located farther from the base unit 52 and still achieve a desired level of signal quality. If the desired level of signal quality can be achieved without the use of repeaters 63a and 63b, then the repeaters 63a and 63b would be unnecessary. In such an example, the base unit 55h could communicate directly with the switching unit 55b.

In a similar manner, the base unit 52 communicates with switching units 55c and 55d through the repeater 63c. Further, the base unit 52 communicates with switching unit 55e through repeater 63d and with switching units 55f and 55g through repeaters 63d and 63e. However, the base unit 52 communicates directly with switching units 55a and 55h without the use of any repeaters. In other embodiments, other numbers and arrangements of switching units 55a-h and repeaters 63a-e are possible.

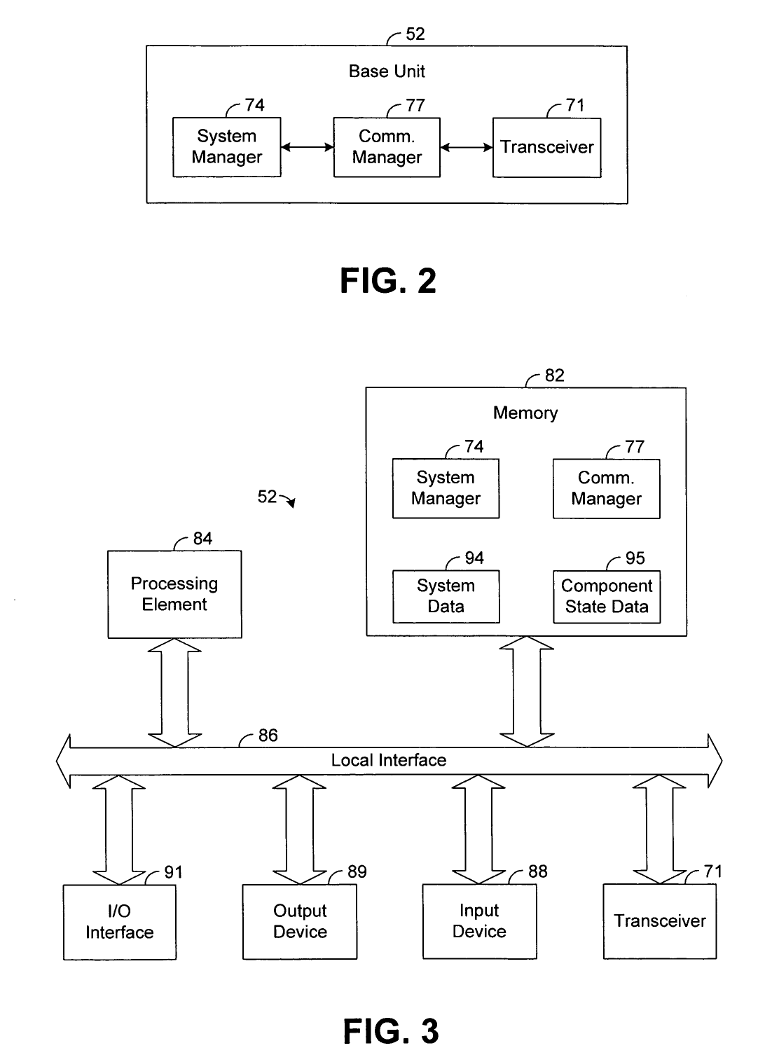

FIG. 2 depicts a base unit 52 in accordance with an exemplary embodiment of the present disclosure. As shown by FIG. 2, the base unit 52 comprises at least one transceiver 71 that transmits and receives wireless signals to and from the switching units 55a-h. A system manager 74 generally controls the operation of the system 50, as will be described in more detail hereafter. A communication manager 77 interfaces the system manager 74 and the transceiver 71. In this regard, messages received from the switching units 55a-h are, if necessary, translated and/or buffered by the communication manager 77 before being passed to the system manager 74. Further, messages from the system manager 74 are, if necessary, translated and/or buffered by the communication manager 77 before being passed to the transceiver 71 for transmission to the switching units 55a-h. If multiple transceivers 71 are employed, the communication manager 77 may coordinate messages among the different transceivers 71.

FIG. 3 depicts a more detailed view of the base unit of FIG. 2 in accordance with one exemplary embodiment of the present disclosure. As shown by FIG. 3, the system manager 74 and the communication manager 77 are implemented in software and stored within memory 82 of the base unit 52. However, in other embodiments the system manager 74 and/or the communication manager 77 may be implemented in hardware, software, or a combination thereof.

Note that the system manager 74 and the communication manager 77, when implemented in software, can be stored and transported on any computer-readable medium for use by or in connection with an instruction execution device that can fetch and execute instructions. In the context of this document, a “computer-readable medium” can be any means that can contain, store, communicate, propagate, or transport a program for use by or in connection with an instruction execution device. The computer readable-medium can be, for example but not limited to, an electronic, magnetic, optical, electromagnetic, infrared, or semiconductor device or propagation medium.

The exemplary embodiment of the base unit 52 depicted by FIG. 3 comprises at least one conventional processing element 84, such as a digital signal processor (DSP) or a central processing unit (CPU), that communicates to and drives the other elements within the base unit 52 via a local interface 86, which can include at least one bus. Furthermore, an input device 88, for example, a keyboard or a mouse, can be used to input data from a user of the unit 52, and a display device 89, for example, a printer or monitor, can be used to output data to the user. In addition, the base unit 52 of FIG. 3 also has an input/output (I/O) interface 91 that allows the base unit 52 to communicate with another device (not shown), such as a personal computer (PC).

As shown by FIG. 3, system data 94 and component state data 95 are stored in memory 82. Based on the system data 94, the system manager 74 determines which scenes are to be implemented by the system 50. For example, upon receiving a request to implement a particular scene, the system manager 74 may consult the system data 94 to determine which scene is identified by the user request. The system manager 74 may then send one or more commands to the affected switching units 55a-h to instruct these units 55a-h as appropriate in order to effectuate the requested scene. Exemplary techniques for effectuating a requested scene will be described in more detail hereafter.

The component state data 95 indicates the current operational state of each load being controlled by the system 50. For example, if a particular light source is being controlled by one of the switching units 55a-h, the component state data 95 indicates whether the light source is activated (i.e., emitting light) and, if so, whether and to what extent the light source is dimmed. Moreover, if the system manager 74, based on the component state data 95, determines that a particular load is to be at a different operational state relative to its current operational state, the system manager 74 may be configured to transmit a command to one of the switching units 55a-h in order to instruct such unit 55a-h to change the state of the particular load.

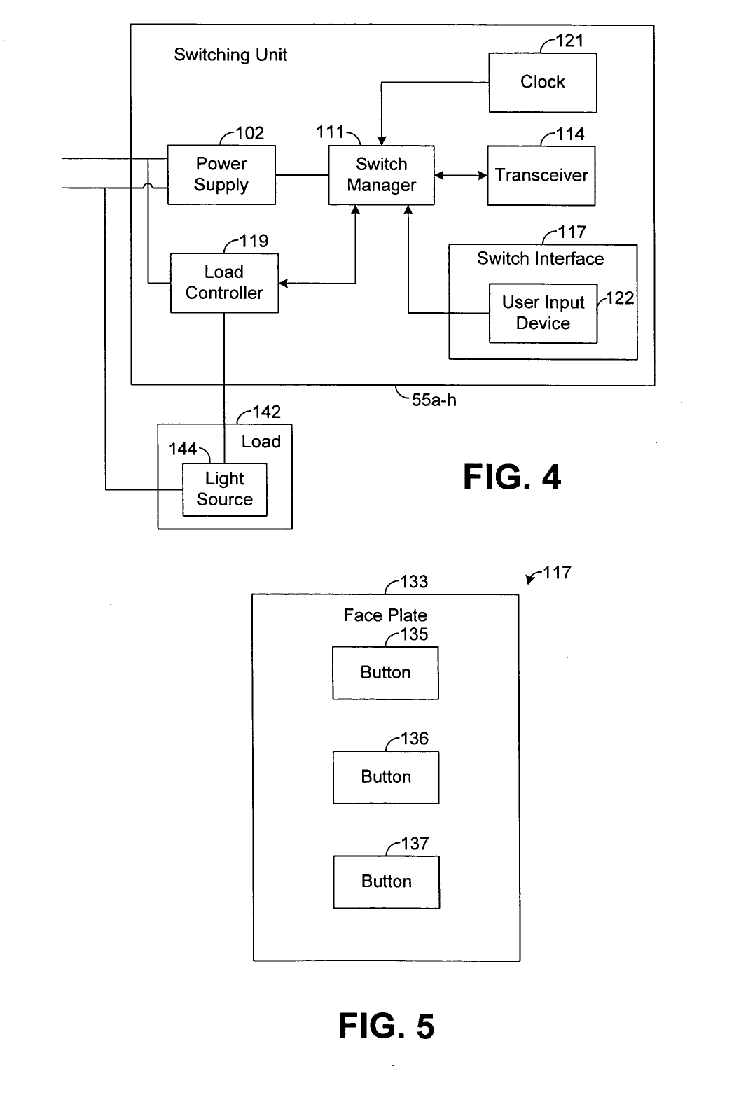

FIG. 4 depicts an exemplary one of the switching units 55a-h. Each of the switching units 55a-h may be configured identical to the exemplary unit shown by FIG. 4. The switching unit 55a-h of FIG. 4 comprises a power supply 102 that is coupled to a pair of electrical connections 104 and 105, referred to as “power connections,” which carry a power signal (e.g., 120 volts (V), 60 Hertz (Hz) alternating current (AC) signal). The power supply 102 converts, if necessary, the power signal into a form that is compatible with various components of the unit 55a-h, such as a switch manager 111, a transceiver 114, a switch interface 117, and/or a load controller 119.

The switch manager 111 generally controls the operation of the switching unit 55a-h, as will be described in more detail hereafter. A clock 121 provides the switch manager 111 with a clock signal that can be used for timing operations, as will be described in more detail hereafter. The transceiver 114 is configured to communicate wireless signals (e.g., RF signals) with other components of the system 50, such as one or more of the repeaters 63a-e, one or more other switching units 55a-h, and/or the base unit 52. In other embodiments, the transceiver 114 can be configured to communicate non-wireless signals.

The switch interface 117 comprises at least one user input device 122, such as, for example, a button or other type of switch, for enabling users to provide inputs to the system 50. Information received from the switch interface 117 may be used by the switch manager 111 to control the operation of the unit 55a-h and/or may be communicated to other components, such as the base unit 52, of the system 50.

FIG. 5 depicts a switch interface 117 in accordance with an exemplary embodiment of the present disclosure. The switch interface 117 of FIG. 5 has a faceplate 133 that can be mounted to a wall of building or other structure or object. Interspersed within the faceplate 133 are a plurality of buttons 135-137. By pressing one or more of the buttons 135-137, a user may provide inputs to the system 50, as will be described in more detail hereafter. Commonly-assigned U.S. patent application Ser. No. (to be determined), attorney docket no. 320306-1040, entitled “Systems and Methods for Indicating Lighting States,” and filed on even date herewith, which is incorporated herein by reference, describes exemplary light indicators corresponding to the buttons 135-137 and used to indicate states of loads and/or scenes controlled by the buttons 135-137. Note that, in other embodiments, other numbers of buttons and/or other types of user input devices may be used in addition to or in lieu of the buttons 135-137.

Referring again to FIG. 4, the load controller 119, operating under the direction and control of the switch manager 111, is configured to control the operational state of at least one load 142. The load 142 can comprise any of various electrical devices, such as at least one light source 144 (e.g., one or more light bulbs or LEDs) and/or other types of electrical devices. For purposes of illustration, it will be assumed hereafter that each load 142 comprises at least one light source 144. However, it should be emphasized that the load 142 can comprise other types of electrical devices in addition to or in lieu of the light source 144.

In the example shown by FIG. 4, the load 142 is electrically coupled to the connection 105 and is electrically coupled to the connection 104 through the load controller 119. By controlling the amount of power received by the load 142 from the connections 104 and 105, the load controller 119 controls the operational state of the load 142. For example, assume that the light source 144 is to be deactivated so that the light source 144 emits no light. In such an example, the load controller 119 can be configured to electrically isolate the load 142 from the connection 104. In such a situation, the light source 144 receives no power from the connections 104 and 105, and the light source 144, therefore, does not emit light. Alternatively, without actually isolating the light source from connection 104, the load controller 119 may adjust the amount of current flowing through it such that there is insufficient current for causing the light source to emit light.

However, if the light source 144 is to be activated, then the load controller 119 can be configured to allow electrical power to flow through the load controller 119 depending on the desired dim state of the light source 144. For example, if the light source 144 is to be activated at full power (i.e., with no dimming), the load controller 119 allows the power signal to fully pass. However, if the light source 144 is to be dimmed, then the load controller 119 clips at least some of the power signal or otherwise adjusts the power signal to achieve the desired dimming effect. For example, if the light source is to be 50% dimmed, the load controller 119 clips or otherwise modifies the power signal such that the light source 144 receives only 50% of the power otherwise available from connections 104 and 105. Techniques for clipping or otherwise adjusting a power signal to provide a desired dimming effect are well-known in the art. Exemplary configurations of at least the power supply 102 and load controller 119, as well as exemplary techniques for dimming the light source 144, are described in commonly-assigned U.S. patent application Ser. No. (to be determined), attorney docket no. 320306-1060, entitled “Systems and Methods for Providing Electrical Power from an Alternating Current Power Source,” and filed on even date herewith, which is incorporated herein by reference.

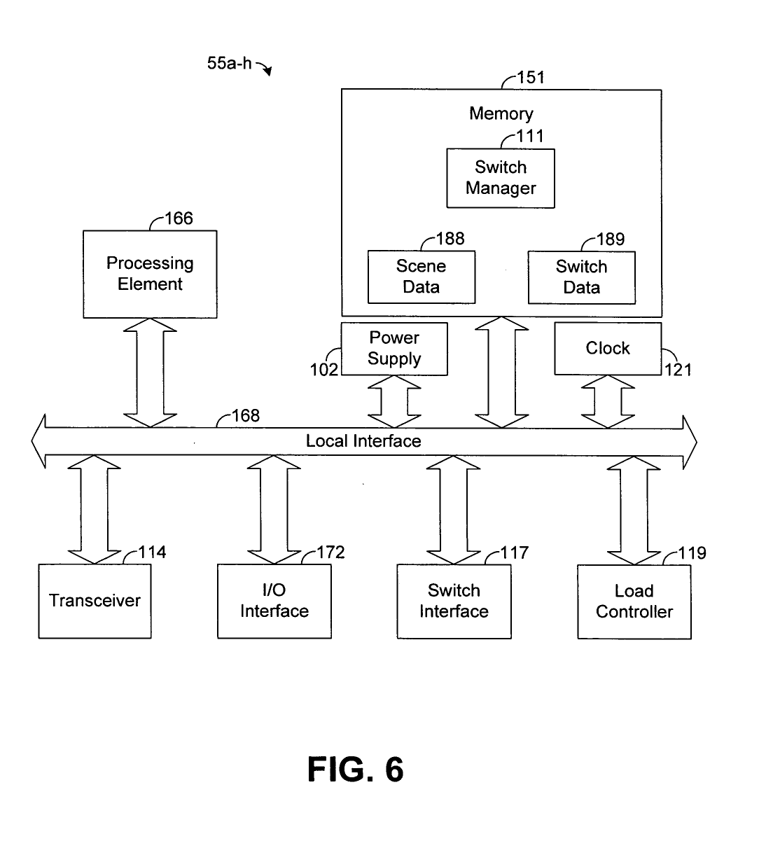

It should be noted that the various components of the switching unit 55a-h of FIG. 4 can be implemented in hardware, software, or a combination thereof. In one exemplary embodiment depicted by FIG. 6, the switch manager 111 is implemented in software and stored within memory 151 of the switching unit 55a-h.

The exemplary embodiment of the switching unit 55a-h depicted by FIG. 6 comprises at least one conventional processing element 166, such as a digital signal processor (DSP) or a central processing unit (CPU), that communicates to and drives the other elements within the switching unit 55a-h via a local interface 168, which can include at least one bus. Furthermore, an input/output (I/O) interface 172 allows data to be exchanged with external components, such as personal computers or other electrical devices.

As shown by FIG. 6, scene data 188 and switch data 189 are stored in memory 151. The scene data 188 indicates how the switch manager 111 is to control the load 142 for each scene that can be implemented, at least in part, by the switching unit 55a-h in which the data 188 is stored. Thus, when the switch manager 111 receives a command instructing it to implement a particular scene, the switch manager 111 can consult the scene data 188 to determine how to modify the operational state of the load 142 in order to comply with the received command. The switch data 189 preferably indicates the current operational state of the load 142 that is connected to the switching unit 55a-h in which the data 189 is stored. If the switch manager 111 determines, based on the switch data 189, that the load 142 is to be in a different operational state relative to its current operational state, the switch manager 111 can instruct the load controller 119 to change the operational state of the load 142.

Each switching unit 55a-h is correlated with a unique identifier that identifies the unit 55a-h relative to the other units 55a-h in the system 50. Such an identifier may be included in a communicated message (e.g., a command) to indicate a source or target for the message. In addition, Each light source 144 in the system 50 is similarly correlated with an identifier, which uniquely identifies the light source 144 relative to other light sources and/or other loads in the system 50. Such identifiers may be useful for facilitating independent control of multiple light sources coupled to the same switching unit 55a-h. Note that, in some embodiments, a light identifier may uniquely identify a light source 144 relative to the other light sources 144 coupled to the same switching unit 55a-h such that a light source 144 and a remote light source 144 could have the same identifier. In such an embodiment, a light source 144 can be uniquely identified with respect to other remote light sources 144 via a combination of its respective light identifier and the identifier of its local switching unit 55a-h (i.e., the switching unit that directly controls the light source).

As described above, in one exemplary embodiment shown by FIG. 5, the switching interface 117 of each switching unit 55a-h comprises three buttons 135-137, referred to herein as “top button 135,” “middle button 136,” and “bottom button 137.” These buttons 135-137 enable a user to submit various inputs, as will be described in more detail hereafter. In one exemplary embodiment, the top button 135 of each switching unit 55a-h controls the state of the switching unit's local load 142. As used herein, the “local load” of a switching unit 55a-h refers to the load 142 that is coupled to and controlled by the unit 55a-h via the unit's load controller 119, as depicted by FIG. 4.

In addition, for each button 135-137, a user is able to input two types of commands, a short press command and a long press command, although other numbers and types of commands may be input per button 135-137 in other embodiments. A short press command occurs when a user continuously presses a button 135-137 for less than a specified time period (e.g., less than 1 second), such as when a user briefly taps the button. A long press command occurs when a user continuously presses a button 135-137 for longer than the specified time period, referred to hereafter as the “short press threshold period.” The amount of time that the user continuously presses and holds a button 135-137 for a long press command is used to control the state of a load affected by the long press command, as will be described in more detail hereafter.

To enable the switch manager 111 to distinguish between short press commands and long press commands, the switch interface 117 provides the switch manager 111 with one or more signals indicating when any of the buttons 135-137 is being pressed by a user. Upon receiving an indication that a user has pressed any of the buttons 135-137, the switch manager 111 begins tracking, based on the clock signal from the clock 121, the amount of time that lapses. The switch manager 111 repetitively compares a time value indicative of the amount of time that has currently lapsed since the foregoing indication to a threshold to determine if the amount of time is longer than the short press threshold period. If the switch manager 111 receives a notification that the pressed button 135-137 has been released before the threshold is exceeded, the switch manager 111 determines that a short press command has been received via the pressed button 135-137. If, on the other hand, the threshold is exceeded without yet receiving a notification that the pressed button 135-137 has been released, the switch manager 111 determines that a long press command is being received via the pressed button 135-137.

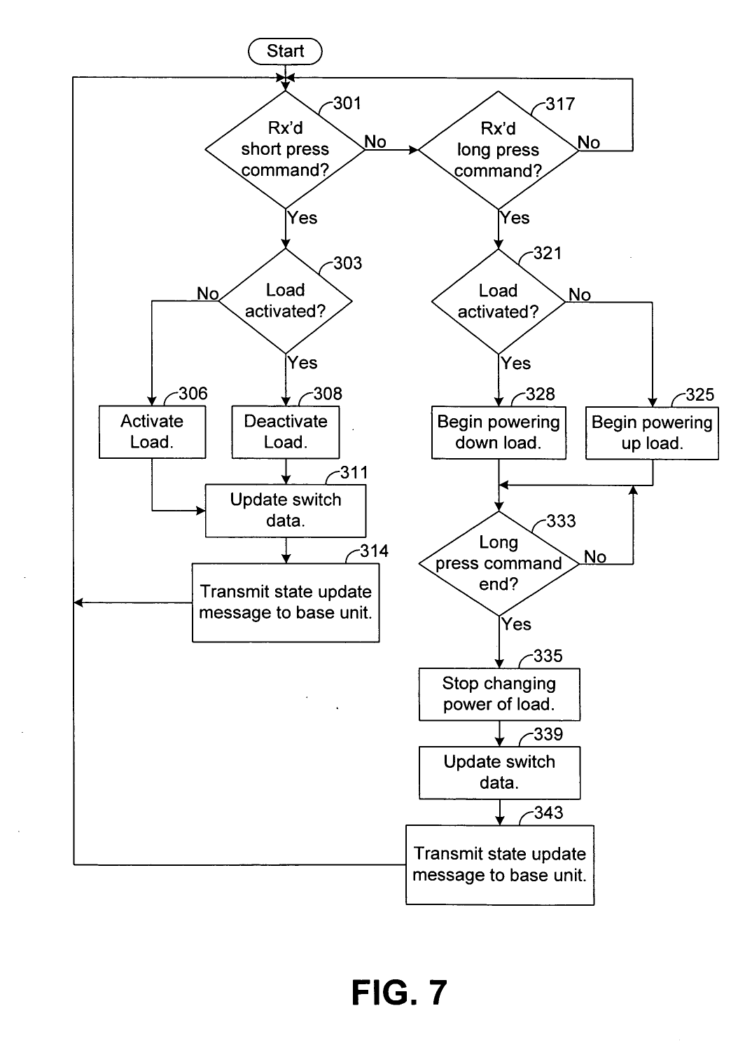

Referring to FIGS. 4 and 5, if a user enters a short press command via the top button 135 of a particular switching unit 55a-h, then the switch manager 111 of the particular switching unit 55a-h is configured to change the state of the unit's local load 142. For example, in response to a detection of a short press command, the switch manager 111 may be configured to consult the switch data 189 (FIG. 6) to determine whether the local load 142 is currently activated, as depicted by blocks 301 and 303 of FIG. 7. In the examples described herein, a load 142 is considered to be “activated” when sufficient power is being delivered to the load 142 via connections 104 and 105 such that the load 142 emits light. A load 142 is considered to be “deactivated” when the load controller 119 prevents the load 142 from receiving sufficient power for causing the load 142 to emit light. In other examples, the loads 142 may be activated and deactivated in different ways.

If the local load 142 is deactivated, then the switch manager 111 activates the load 142, as depicted by block 306 of FIG. 7. In this regard, the switch manager 111 instructs the load controller 119 to provide sufficient power for activating the load 142. In response, the load controller 119 increases the power delivered to the load 142 such that the load 142 emits light. In the instant embodiment, the switch manager 111 requests a load level of 100%. As used herein, the “load level” refers to the percentage of available power to be delivered to the load. In this regard, a load level of 100% means that the load controller 119 does not reduce any of the power available from connections 104 and 105. A load level of 50%, on the other hand, indicates that the load controller 119 clips or otherwise adjusts the power signal from connections 104 and 105 so that only 50% of the total power available from the connections 104 and 105 is delivered to the load 142. In such an example, the brightness of the light source 144 should be reduced by about the same percentage as the reduction in power. Thus, the light source 144 at a load level of 50% should appear about half as bright as the source 144 at a load level of 100%. Moreover, the light source 144 should be at a load level of 100% and emit light at maximum brightness if it is activated via block 306 of FIG. 7. In other embodiments, the load level may be set to a different value via block 306.

Note that, in one exemplary embodiment, the component state data 95 (FIG. 3) associates a respective load level value with the identifier of each light source 144 in the system 50. Each load level value indicates the current load level for the associated light source 144. Thus, the system manager 74 may consult the component state data 95 to determine the current load level of any light source 144 in the system 50.

If the switch manager 111 determines, in block 303 of FIG. 7, that the local load 142 is activated, then the switch manager 111 deactivates the load 142, as depicted by block 308 of FIG. 7. In this regard, the switch manager 111 instructs the load controller 119 to interrupt power to the load 142. In response, the load controller reduces the power delivered to the load 142 such that it does not emit light. In such a state, the light source 144 goes to a load level of 0%. In other embodiments, the load level may be set to a different value via block 308.

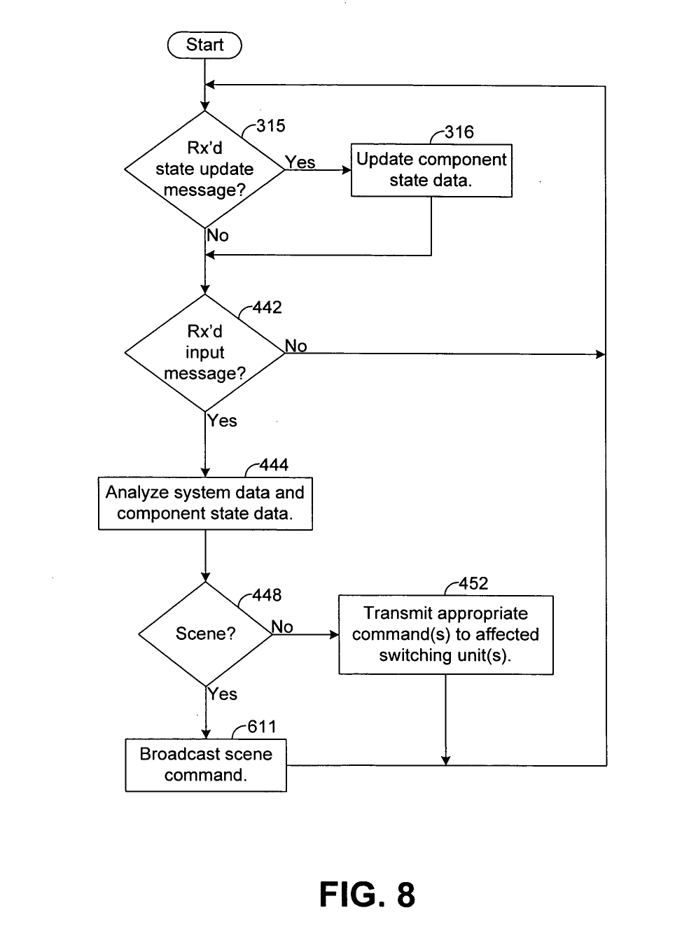

As depicted by block 311, the switch manager 111 updates the switch data 189 (FIG. 6) to account for the load's current state after implementation of either block 306 or 308. The switch manager 111, as depicted by block 314, also transmits a message, referred to hereafter as a “state update message,” to the base unit 52 indicating the current state of the local load 142 after performance of block 306 or 308. Upon receiving this state update message, the base unit 52 updates the component state data 95 (FIG. 3) so that this data 95 correctly indicates the current state of the affected load 142, as indicated by blocks 315 and 316 of FIG. 8. To enable such an update, the state update message includes the identifier of the switching unit 55a-h that received the short press command and that updated its local load 142 based on such command, as well as data indicating the current state of the local load 142. For example, the message may include a value indicating the current load level of the load 142 as it exists after performance of block 306 or 308. Based on such information, the system manager 74 (FIG. 3) may update the component state data 95 by changing the load level value associated with the local load 142 of the identified switching unit 55a-h.

If a user is entering a long press command via the top button 135 of a particular switching unit 55a-h, then the switch manager 111 of the particular switching unit 55a-h is configured to detect the long press command in block 317 of FIG. 7. Such a detection can be made by determining that the button 135 has been continuously pressed for longer than the short press threshold period.

If a determination is made that the user is entering a long press command, then the switch manager 111 is configured to change the state of the unit's local load 142. For example, in response to initiation of a long press command, the switch manager 111 may be configured to consult the switch data 189 (FIG. 6) to determine whether the local load 142 is currently activated, as depicted by block 321 of FIG. 7. If the local load 142 is deactivated, then the switch manager 111 begins powering up the load 142, as depicted by block 325 of FIG. 7. In particular, the switch manager 111 instructs the load controller 119 to increasingly provide power to the load 142 at a predefined rate. As used herein, the term “soft rate” refers to a value indicating the rate at which power to a load is to be changed.

In the exemplary embodiments described herein, the soft rate is a time value indicating the amount of time that it would take to linearly power a load from a load level of 0% to a load level of 100%. For example, a load rate of 5 is satisfied if a load is linearly powered up at a rate such that the load would go from a 0% load level to a 100% load level in five seconds. Thus, in block 325, the switch manager 111 provides a request to the load controller 119 to increasingly provide power to the load 142 at a rate equal to a predefined soft rate. In response, the load controller 119 controls the amount of power allowed to pass such that the power delivered to the load 142 is increased at a rate equal to the requested soft rate. The load controller 119 allows the power to increase until either the 100% load level is reached or until the load controller 119 receives a command to stop the power increases, as will be described in more detail below.

If a determination is made in block 321 that the local load 142 is activated, then the switch manager 111 begins powering down the load 142, as depicted by block 328 of FIG. 7. In particular, the switch manager 111 instructs the load controller 119 to reduce the power provided to the load 142 at the switching unit's predefined soft rate. In response, the load controller 119 controls the amount of power allowed to pass such that the power delivered to the load 142 is decreased at a rate equal to the requested soft rate. The load controller 119 allows the power to decrease until either the 0% load level is reached (i.e., the load is deactivated) or until the load controller 119 receives a command to stop the power decreases, as will be described in more detail below.

Moreover, once the user presses the top button 135 to enter a long press command, the light source 144 begins to either increase in brightness or decrease in brightness due to performance of either block 325 or 328. When the brightness reaches a desired level, the user can stop pressing the top button 135 to indicate that the brightness change should stop. Such an event ends the long press command being entered. The switch manager 111 detects this end in block 333 of FIG. 7 and, in response, transmits a command instructing the load controller 119 to stop changing the power delivered to the load 142, as depicted by block 335. If the load level has not reached 100% (in the case where the power is being increased) or 0% (in the case where power is being decreased), the load controller 119 stops changing the power being provided to the load 142 in response to the foregoing command. Thereafter, the load level is kept constant at the level in effect at the time that the command is received by the load controller 119. Thus, the brightness of the light source 144 is kept constant once the user releases the top button 135 from its activation state.

Since the state of the load 142 has changed in response to the long press command, the switch manager 111 updates the switch data 189 (FIG. 6) in block 339 so that this data 189 correctly reflects the current state of the load 142. The switch manager 111 also transmits a state update message to the base unit 52 indicating the current state of the local load 142, as indicated by block 343. Based on this state update message, the base unit 52 updates the component state data 95 (FIG. 3) so that this data 95 correctly indicates the current state of the load 142 affected by the long press command, as indicated by blocks 315 and 316 of FIG. 8. To enable such an update, the state update message includes the identifier of the switching unit 55a-h that received the long press command and that updated its local load 142 based on such command, as well as data indicating the current state of the local load 142. For example, the message may include a value indicating the current load level of the load 142 as it exists after performance of block 335. Based on such information, the system manager 74 (FIG. 3) may update the component state data 95 by changing the load level value associated with the identified switching unit 55a-h.

Note that switch manager 111 is able to control the state of its local load 142 based on inputs from the top button 135 regardless of whether the switch manager 111 is able to communicate with the base unit 52. Thus, if the base unit 52 becomes inoperable for some reason or if communication with the base unit 52 or other remote components is lost, the switch manager 111 is still able to control the state of its local load 142 based on user inputs received via the top button 135.

The other buttons 136 and 137 can be used to control different components of the switching unit's local load 142. For example, the top button 135 can be used to control one light source 144, and at least one of the other buttons 136 and 137 can be used to control other light sources 144 in a similar manner described above for the top button 135. However, in one exemplary embodiment, each light source 144 of the local load 142 is controlled via the inputs from the top button 135, as described above, and the other buttons 136 and 137 are used for receiving inputs for controlling other aspects of the system 50, such as the operational states of remote loads or scenes. Further, it is unnecessary for the switch manager 111 to be aware of how an input from one of the buttons 136 or 137 controls a remote load or scene. Such information may reside at the base unit 52 or at a remote switching unit 55a-h.

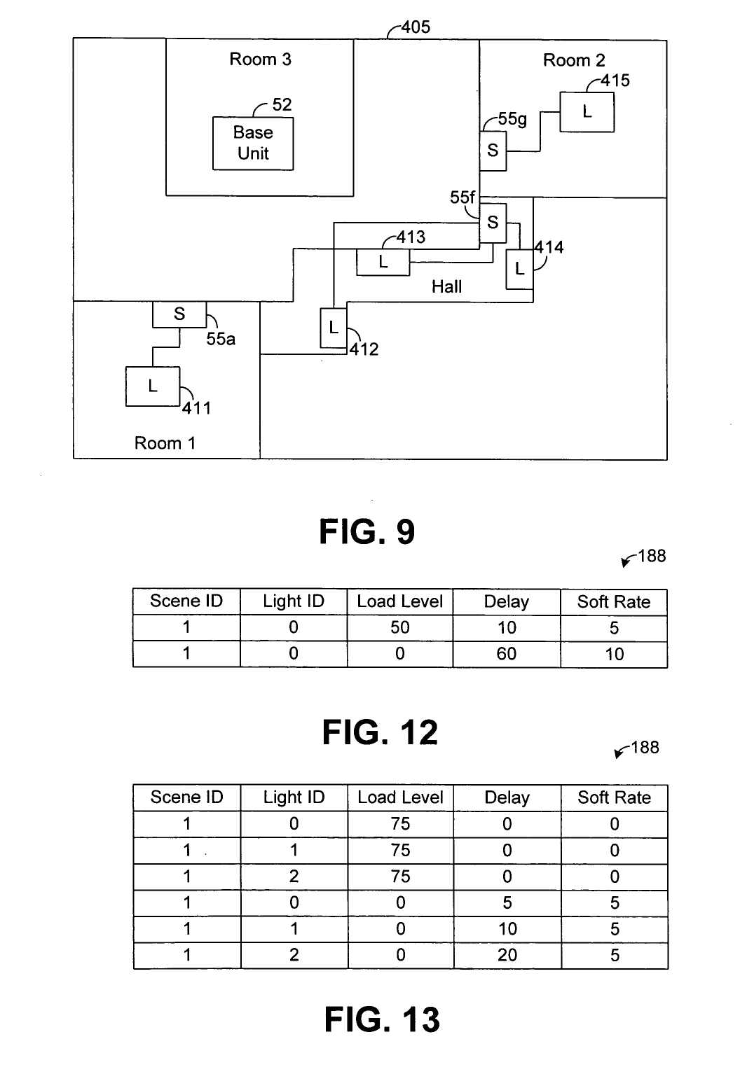

To better illustrate the foregoing, refer to FIG. 9, which illustrates an exemplary lighting system 50 implemented within a house 405. Assume that the house 405 of FIG. 9 has several rooms, including three rooms referred to as “Room 1,” “Room 2,” and “Room 3.” The house 405 also has a hall (hereinafter “Hall”) extending from Room 1 to Room 2. Switching unit 55a is mounted on a wall within Room 1. Further, a light source 411 within Room 1 is coupled directly to and controlled by the switching unit 55a. Switching unit 55f is mounted on a wall within the Hall. Three light sources 412-414 within the Hall are coupled directly to and controlled by the switching unit 55f. In addition, switching unit 55g is mounted on a wall within Room 2. A light source 415 within Room 2 is coupled directly to and controlled by the switching unit 55g. Further, the base unit 52 resides in room 3. Although each light source 411-415 is coupled directly to and controlled by a respective switching unit 55a, 55f, or 55g in the same room, it is unnecessary for a light source and its controlling switching unit to be in the same room in other examples.

For illustrative purposes, assume that the middle button 136 (FIG. 5) of the switching unit 55g is to be used for remotely controlling the operational states of light sources 412-414 in a similar manner described above for controlling the local load in the example described with FIG. 7. Thus, if the middle button 136 of unit 55g receives a short press command, the light sources 412-414 are to be immediately (i.e., at a soft rate of 0) activated to a load level of 100% or deactivated (i.e., load level of 0%) depending on the current states of the light sources 412-414. However, if the middle button 136 of unit 55g receives a long press command, then the light sources 412-414 are to be powered up or down, depending on the current states of these light sources 412-414, at a predefined soft rate until the long press command is ended or until a load level of 0% or 100% is reached.

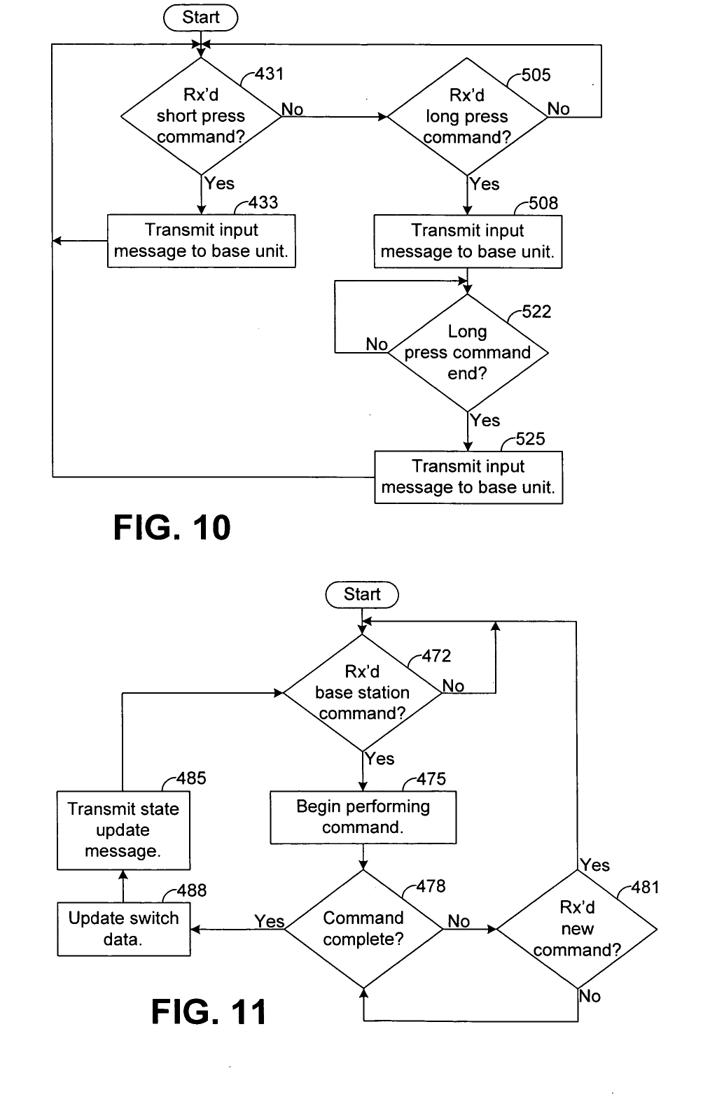

Assume that a user enters a short press command via the middle button 136 of the switching unit 55g. In such an example, the switch manager 111 of the unit 55g, upon determining that a short press command has been received from the button 136, transmits an input message to the base unit 52, as depicted by blocks 431 and 433 of FIG. 10. As used herein, an “input message” is a message indicating that a user input has been received. In accordance with one exemplary embodiment, each input message indicates the type of input received (e.g., either short press command or long press command), which switching unit 55a-h received the input, and which button 135-137 of this unit 55a-h received the input. Thus, in the instant example, the switch manager 111 of unit 55g includes the following information in the input message transmitted via block 433: the identifier of switching unit 55g, an identifier that identifies the pressed button 136 relative to the other buttons 135 and 137, and data indicating that a short press command was received. Note that it is unnecessary for the switching unit 55g to be aware that the input from the middle button 136 is to be used for controlling the light sources 412-414 in the Hall.

Upon receiving the input message from switching unit 55g, the base unit 52 analyzes the system data 94 (FIG. 3) based on the input message, as depicted by blocks 442 and 444 of FIG. 8. The system data 94 indicates how the system 50 is to respond to each possible user input. Thus, in the instant example, the system data 94 indicates that the light sources 412-414 coupled to the switching unit 55f are to be immediately activated (i.e., a soft rate of 0) in response to a short press command received via the middle button 136 of the switching unit 55g if the lights sources 412-414 are currently deactivated (i.e., at a load level of 0). If the light sources 412-414 are activated (i.e., at a load level greater than a load level of 0), the system data 94 indicates that the light sources 412-414 are to be deactivated (i.e., changed to a load level of 0). Assume that the light sources 412-414 are currently off. Thus, in the instant example, the system manager 74 compares the data in the input message to the system data 94 and component state data 95 and determines that the light sources 412-414 are to be immediately activated. Note that, in the instant example, the system data 94 does not indicate that the input message triggers activation of a scene, which will be described in more detail hereafter. Therefore, the system manager 74 makes a “no” determination in block 447 of FIG. 8.

Moreover, in block 452 of FIG. 8, the system manager 74 requests transmission of a command for changing the operational states of the light sources 412-414, as appropriate, and the communication manager 77 transmits such command to the switching unit 55f. This command includes the identifier of the switching unit 55f so that this unit 55f knows to respond to the command and so that non-identified switching units know that they are not to respond to the command. The command also indicates the manner that the light sources are to be controlled. For example, the command may include the desired load level value (i.e., 100 in the instant example) and the desired soft rate value (i.e., 0 in the instant example). The command may also identify each of the light sources 412-414 to be changed in response to the command. The command may further include a delay value indicating the amount of time that is to lapse before the identified light sources 412-414 are to be controlled according to the other parameters in the command.

For example, a delay value of 0 within a command may indicate that an identified switching unit 55f is to immediately begin controlling the identified light sources 412-414 according to the load level value and soft rate value in the command. However, a delay value of 30 may indicate that the identified switching unit 55f is to wait 30 seconds (or some other unit of time) before adjusting the operational states of the identified light sources 412-414.

Upon receiving a command from the base unit 52, each identified switching unit 55a-h performs the requested command, as indicated by blocks 472 and 475 of FIG. 11. Thus, upon receiving the command transmitted from the base unit 52 in the instant example, the switching unit 55f controls the states of the light sources 412-414, as instructed. In the instant example, the switch manager 111 (FIG. 4) causes the load levels of the light sources 412-214 to be changed to 100% at a soft rate of 0, thereby immediately activating the light sources 412-414 such they emit light at maximum brightness. Since the soft rate is 0, it is unlikely that the switching unit 55f would receive another command before completing the instant command. Thus, the switch manager 111 of the unit 55f would likely determine that the command has been completed in block 478 before determining, in block 481, that a new command has been received.

Upon determining that the command has been completed in block 478, the switch manager 111 of the unit 55f updates the switch data 189 (FIG. 6) within this unit 55f so that the data 189 correctly indicates the state of the light sources 412-414, as changed in response to the instant command, as indicated by block 485 of FIG. 11. The switch manager 111 also transmits a state update message to the base unit 52 so that the base unit 52 can update the component state data 95 (FIG. 3) to correctly indicate the changed state of the light sources 412-414, as indicated by block 488 of FIG. 11.

In another example, assume that a user at switching unit 55g does not desire to change the states of the lights 412-414 to a 0% or 100% load level but rather to some load level therebetween. Further assume that the system 50 is configured to enable such a change via a long press command entered via the middle button 136 of the switching unit 55g. In such an example, the user presses and holds the middle button 136 of the switching unit 55g. When the button 136 is pressed for longer than the short press threshold period, the switch manager 111 of the unit 55g determines that a long press command is being received, as indicated by block 505 of FIG. 10. In response, the switch manager 111 transmits an input message to the base unit 52, as indicated by block 508. This message indicates that the middle button 136 of the unit 55g has received the start of a long press command.

Upon receiving the input message, the communication manager 77 (FIG. 3) of the base unit 52 forwards the message to the system manager 74. The system manager 74 then compares the data in the message to the system data 94 shown in FIG. 3 in order to determine what action is to be taken in response to the input message, as indicated by block 444 of FIG. 8. In the instant embodiment, the data 94 and component state data 95 may indicate that the light sources 412-414 are to be powered up or down at a specified soft rate (e.g., 5) depending on the current states of the switches 412-414. In such an example, the system manager 74 may be configured to check the states of the light sources 412-414 by consulting the component state data 95 (FIG. 3). Based on the data 94 and 95, as well as the input message, the system manager 74 defines a command to be transmitted to the switching unit 55f for controlling the light sources 412-414 as appropriate, as indicated by block 452 of FIG. 8.

For example, assuming that the data 95 indicates that the light sources 412-414 are currently deactivated (i.e., at a load level of 0), the system manager 74 may define a command instructing the switching unit 55f to power up the light sources 412-414 to a load level of 100% at the predefined soft rate (e.g., 5). Such a command may include the identifier of the unit 55f, the desired load level (i.e., 100 in this example), and the desired soft rate (i.e., 5 in this example). The system manager 74 passes the command to the communication manager 77, which transmits the command to the switching unit 55f via transceiver 71.

Upon receiving the command transmitted from the base unit 52 in the instant example, the switching unit 55f controls the states of the light sources 412-414, as instructed. Thus, in the instant example, the switch manager 111 (FIG. 4) causes the load levels of the light sources 412-214 to be changed to 100% at a soft rate of 5, thereby activating the light sources 412-414 such they emit light at increasingly higher levels of brightness. If the load levels of the light sources 412-414 reach the level specified by the command (i.e., 100% in the instant example), then the switch manager 111 of the unit 55f determines that the command has been completed in block 478 of FIG. 11 and proceeds to block 485, similar to the example described above.

However, assume that, as the brightness of each light source 412-414 increases, the user decides that the light sources 412-414 have reached a desired load level. Accordingly, the user releases the button 136 before the load levels of the light sources 412-414 reach 100%. When the user releases the button 136, the switch manager 111 of the switching unit 55g in Room 2 detects this event and transmits another input message, as indicated by blocks 522 and 525 of FIG. 10. This input message indicates that the long press command being received by the button 136 of switching unit 55g has stopped or, in particular, the user has stopped pressing such button 136.

In response to the foregoing input message, the system manager 74 (FIG. 3) consults the system data 94 in block 444 of FIG. 8 and determines that the input message pertains to the switching unit 55f. Moreover, the system manager 74 generates a command instructing the switching unit 55f to stop changing the states of light sources 412-414, and this command is transmitted to the switching unit 55f in block 452 of FIG. 8.

If this command is received by the switching unit 55f before the load levels of light sources 412-414 reach their target (i.e., 100% in the instant example), then the switch manager 111 of the unit 55f makes a “yes” determination in block 481. The switch manager 111 then controls the states of the light sources 412-414 according to the newly received command. In the instant example, the switch manager 111 transmits a request to the load controller 119 of the unit 55f instructing the load controller 119 to stop adjusting the load levels of the light sources 412-414 so that these load levels remain at their current state. In response, the load controller 119 stops increasing the load levels of the light sources 412-414.

In addition, the switch manager 111 updates the switch data 189 (FIG. 6) such that this data 189 correctly indicates the current states of the light sources 412-414. In this regard, the load controller 119 preferably comprises a component, such as an ammeter (not specifically shown), capable of detecting or otherwise determining the current load levels of the light sources. After stopping changes to the load levels of the light sources 412-414, the load controller 119 provides a value indicative of the current load levels of the light sources 412-414, and the switch manager 111 uses this value to update the switch data 189. The switch manager 111 also transmits a state update message to the base unit 52, as indicated by block 488 of FIG. 11, to enable the system manager 74 of the base unit 52 to update the component state data 95 based on the current load levels of the light sources 412-414.

As described in the above examples, the base unit 52 can receive inputs from various switching units 55a-h and determine which actions are to be performed based on these inputs. In some situations, it may be desirable for a user to predefine at least one scene that pertains to multiple switching units 55a-h. For example, a user could program the system 50 such that, for one scene, loads of various switching units 55a-h are automatically controlled in a predefined manner in response to a user input for activating the scene. As a mere example, a particular scene could be defined in which a light source controlled by one switching unit 55a-h is activated and a light source controlled by another switching unit 55a-h is deactivated. Another scene could be defined such that all of the lights in a house are automatically activated to a load level of 100% or some other load level. A user might activate such a scene when the user is frightened by an unexpected sound or think that an intruder is attempting to gain access to the user's house. Any given scene, when activated, might control all of the lights in the system 50 or only some of the lights. Further, for different scenes, different loads may be controlled in different manners.

Data indicating how the loads should be controlled for various scenes can be stored at the base unit 52. When a user requests activation of a particular scene, the base unit 52 may then consult such data and determine which loads are affected by the requested scene. The base unit 52 may then transmit commands to the switching units 55a-h controlling such loads in order to change the states of these loads in accordance with the requested scene. For example, if a particular light source is to be activated to a load level of 50% for a particular scene requested by a user, the base unit 52 may transmit a command to the switching unit 55a-h controlling this light source. The command may include sufficient information, such as the appropriate light identifier, load level value, and soft rate value, for enabling the light source to be appropriately controlled.

However, in one exemplary embodiment, which will be described in more detail hereafter, the information indicating how a particular light source is to be controlled for a scene is stored at the switching unit 55a-h controlling the light source, not the base unit 52. Thus, the process of implementing the scene may be simplified, and the scene may be implemented more efficiently. In this regard, the base unit 52 may communicate to the switching units 55a-h information indicating when a user submits a request for implementing a particular scene. Each of the switching units 55a-h affected by the scene may then consult the data stored therein to determine how it is control its respective local load. Thus, it is unnecessary for the base unit 52 to inform each unit 55a-h how it is to respond to the requested scene.

To better illustrate the foregoing, assume that a user desires to define a particular scene, referred to as “movie watching scene.” Referring to FIG. 9, assume that Room 1 is a media room with a large screen television. Further, assume that the movie watching scene can be triggered by entering a short press command via the bottom button 137 of the switching unit 55g in Room 2. As an example, a user might enter a short press command via this button 137 to implement the movie watching scene just before the user is to walk down the Hall and into the Room 1 to watch a movie.

Scene data 188 (FIG. 6) at the switching unit 55a may be defined to indicate that, when the movie watching scene is implemented, the light source 411 is to be powered to a load level of 50% at a soft rate of 0 and delay of 10 seconds. In this regard, assume that it is expected to take approximately 20 seconds for a user to walk from Room 2 to Room 1. Thus, having a delay of 10 seconds after activation of the movie watching scene should ensure that the switching unit 55a begins powering the light source 411 toward a load level of 50% about 10 seconds before a user reaches Room 1 if the user begins walking down the Hall to Room 1 upon activating the movie watching scene via switching unit 55g. Further, with a soft rate of 5, the light source 411 should reach the target load level of 50% within 5 seconds. Thus, the light source 411 should be at the 50% load level at least about 5 seconds before the user enters Room 1.

FIG. 12 depicts an exemplary set of scene data 188 that may be stored at the switching unit 55a for implementing the aforedescribed scene. The data 188 includes a plurality of entries with each entry having a scene identifier (ID), a light identifier (ID), a target load level, a delay value, and a soft rate value. Assume that the movie watching scene is assigned an identifier of “1” and the light source 411 is assigned the identifier “0,” which uniquely identifies the light source 411 with respect to other light sources (not shown) controlled by the switching unit 55a. The first entry of the data 188 of FIG. 12 indicates that, for the movie watching scene (i.e., scene 1), the light source 411 is to begin powering the light source 411 to a 50% load level 10 seconds after activation of the movie watching scene at a soft rate of 5.

Note that the last entry, which also has a scene 1 identifier, indicates that the light source 411 is to be powered down to a load level of 0% (i.e., deactivated) 60 seconds after activation of the scene at a soft rate of 10. Thus, the light source 411, in addition to being powered to a specified load level (i.e., 50% in this example), is later gradually powered down until it is deactivated. Thus, if a user enters the Room 1 about 20 second after activation of the movie watching scene, the user should have about 40 seconds to get situated (e.g., to find a seat, find a remote control, and/or begin playing a movie) before the switching unit 55a begins to power down the light source 411.

FIG. 13 illustrates exemplary scene data 188 that may be stored in the switching unit 55f. Assume that light source 412 has a light identifier of “0,” that light source 413 has a light identifier of “1,” and that light source 414 has a light identifier of “2.” The scene data 188 of FIG. 13 indicates that each of the light sources 412-414 is to be powered to a load level of 75% at a soft rate of 0 with no delay upon activation of the movie watching scene (i.e., scene 1). Further, the data 188 also indicates that the switching unit 55f is to begin powering down the light source 414 to a target load level of 0% at a soft rate of 5 after 5 seconds have elapsed since activation of the movie watching scene. In this regard, it may be expected that a user who activates the movie watching scene would pass light source 414 about 5 seconds after activation of this scene via unit 55g if the user began walking toward Room 1 upon activation. Thus, it is anticipated that the light source 414 should begin powering down just after the user passes it.

The data 188 further indicates that the switching unit 55f is to begin powering down the light source 413 to a target load level of 0% at a soft rate of 5 after 10 seconds have elapsed since activation of the movie watching scene. In this regard, it may be expected that a user who activates the movie watching scene would pass light source 413 about 10 seconds after activation of this scene via unit 55g if the user began walking toward Room 1 upon activation. Thus, it is anticipated that the light source 413 should begin powering down just after the user passes it. The data 188 also indicates that the switching unit 55f is to begin powering down the light source 412 to a target load level of 0% at a soft rate of 5 after 15 seconds have elapsed since activation of the movie watching scene. In this regard, it may be expected that a user who activates the movie watching scene would pass light source 412 about 15 seconds after activation of this scene via unit 55g if the user began walking toward Room 1 upon activation. Thus, it is anticipated that the light source 412 should begin powering down just after the user passes it.

An exemplary use of the system 50 to effectuate the exemplary movie watching scene described above will be described in more detail hereinbelow.

In this regard, assume that a user activates the movie watching scene by tapping the bottom button 137 of the switching unit 55g just before he begins walking toward Room 1 through the Hall. The switch manager 111 of the unit 55g detects the short press command and transmits an input message to the base unit 52 in block 433 of FIG. 10. The input message indicates that a short press command has been received via button 137 of the switching unit 55g. The system manager 74 (FIG. 3) compares the data from the input message with the system data 94 and component state data 95 (FIG. 3) to determine what actions should be taken. The data 94 preferably indicates that a short press command received via the bottom button 137 of the switching unit 55g corresponds to scene 1 (i.e., the movie watching scene), and the component state data 95 indicates that this scene is currently deactivated. Thus, by consulting that data 94 and 95, the system manager 74 determines that a request for activating a scene (i.e., scene 1) has been received in block 448 of FIG. 8.

In response, the system manager 74 instructs the communication manager 77 to broadcast a scene command to each of the switching units 55a-h. A “scene command,” as used herein, includes the identifier of a requested scene. Note that, in the instant example, it is unnecessary for the base unit 52 to be aware of how each unit 55a-h behaves during the requested scene. Further, since the scene command is broadcast to each unit 55a-h, it is unnecessary for the base unit 52 to even be aware of which switching units 55a-h are affected by the requested scene. Moreover, based on the instructions from the system manager 74, the communication manager 77 transmits, via transceiver 71 in block 611 of FIG. 8, a single scene command identifying scene 1 and received by each switching unit 55a-h. In addition, the system manager 74 preferably updates the component state data 95 to indicate that scene 1 has been activated.

In the instant example, the requested scene only affects the switching units 55a and 55f. In such an example, the scene data 188 (FIG. 6) of the remaining switching units 55 b-e, g, and h do not have any entries identifying the requested scene or, in other words, scene 1. Upon receiving the scene command, these switching units 55b-e, g, and h consult the scene data 188 stored therein. Since there is no entry corresponding to the requested scene, the switching units 55 b-e, g, and h take no action to adjust the state of their respective local load.

The scene data 188 of switching unit 55f, on the other hand, includes several entries corresponding with the requested scene, as depicted by FIG. 13. Thus, the switch manager 111 of the switching unit 55f begins tracking time since it received the scene command. Further, since there is no delay associated with the first three entries shown in FIG. 13 (i.e., the delay value associated with each such entry is 0), the switch manager 111, upon receiving the scene command, instructs the load controller 119 of the unit 55f to power each of the light sources 412-414 to a load level of 75% at a soft rate of 0. In response, the load controller 119 allows 75% of the total power available from connections 104 and 105 to reach the light sources 412-414. In the absence of any intervening commands, the switch manager 111, 5 seconds later, instructs the load controller 119 to begin powering down the light source 414 to a target load level of 0% at a soft rate of 5. 5 seconds after that, the switch manager 111 instructs the load controller 119 to begin powering down the light source 413 to a target load level of 0% at a soft rate of 5. 10 seconds after that (i.e., 20 seconds after receiving the scene command), the switch manager 111 instructs the load controller 119 to begin powering down the light source 412 to a target load level of 0% at a soft rate of 5. Upon completing the scene command, the switch manager 111, in blocks 485 and 488 of FIG. 11, updates the switch data 189 (FIG. 6) to account for the changes in the states of the light sources 412-414 and transmits a state update message to the base unit 52 to enable the base unit 52 to update the component state data 95 (FIG. 3).

The scene data 188 of switching unit 55a also includes several entries corresponding with the requested scene, as depicted by FIG. 12. Thus, the switch manager 111 of the switching unit 55a begins tracking time since it received the scene command. In the absence of any intervening commands, 10 seconds after receiving the scene command, the switch manager 111 instructs the load controller 119 of the unit 55a to power the light source 411 to a load level of 50% at a soft rate of 5. In response, the load controller 119 begins adjusting power provided to the light source 411 as instructed. 60 seconds after receiving the scene command, the switch manager 111 instructs the load controller 119 to begin powering down the light source 411 to a target load level of 0% at a soft rate of 10. Upon completing the scene command, the switch manager 111, in blocks 485 and 488 of FIG. 10, updates the switch data 189 (FIG. 6) to account for the changes in the state of the light source 411 and transmits a state update message to the base unit 52 to enable the base unit 52 to update the component state data 95 (FIG. 3).

Note that it is unnecessary for the switch manager 111 to wait for completion of the scene command before transmitting any state update messages. For example, the switch manager 111 may transmit a state update message once the light source 411 is powered up to a load level of 50% or at some other point or points during the scene. Thus, the component data 95 (FIG. 3) can be repetitively updated during the scene to reflect various changes in the state of the light source 411 as the scene is progressing.

Accordingly, each of the affected switching units 55a and 55f takes the appropriate steps to implement the requested scene without the base unit 52 having to specify such steps or even having any knowledge of these steps. Moreover, the base unit 52 simply determines that scene 1 has been requested and generates a command to trigger each affected switching unit 55a-h to implement the requested scene. It is up to each individual unit 55a-h to determine if the requested scene applies to that unit 55a-h and, if so, to determine what actions should be taken to implement the requested scene.

Similar to the way that long press commands can be used to dynamically set a load level of a particular load to a desired level, a long press command can also be used to dynamically control progression of a requested scene. For example, the system data 94 may be defined such that a long press command entered via the bottom button 137 of the switching unit 55g corresponds to scene 1. Thus, in response to an input message indicating that a long press command has been received via button 137 of the switching unit 55g, the system manager 74 may be configured to instruct the communication manager 77 to broadcast a scene command identifying scene 1. Thus, as described above the affected switching units 55a and 55f may begin implementing scene 1. However, once the user stops pressing the bottom button 137 of switching unit 55g, the switch manager 111 of the unit 55g may be configured to detect an end to the long press command and transmit an input message indicative of such detection. In response, the system manager 74 may request that the communication manager 77 transmit a stop scene 1 command indicating that scene 1 is to be stopped. In response to this command, the switching units 55a and 55f may be configured to stop changing the state of the light sources 411-414 if scene 1 has not been completed. Thus, the states of the light sources 411-414 remain constant relative to the current states of these light sources 411-414 when the stop scene 1 command is broadcast. The light sources 411-414 remain in such constant states until another event, such as another user input, causes at least one of such states to be changed.

Note that the system data 94 (FIG. 3) and/or the scene data 188 (FIG. 6) can be updated to change how the system 50 behaves. For example, the data 188 defining a scene for a particular unit 55a-h can be changed in order to change how that unit 55a-h implements the scene. Further, a scene can be added or deleted by adding or deleting entries corresponding to such scene. Further, the system data 94 can be changed in order to change how the system manager 74 responds to a particular user input. Such updates can be received by input device 88 (FIG. 3). For updates affecting a remote switching unit 55a-h, the communication manager 77 can transmit such updates via transceiver 71 to the appropriate units 55a-h.

It should be noted that the exemplary scenes and techniques described above for controlling the states of the loads of the system 50 are presented for illustrative purposes. Many other types of scenes and techniques for controlling such loads are possible in other embodiments and would be apparent to one of ordinary skill in the art upon reading this disclosure.

In addition, the switching units 55a-h have been described above in the context of a lighting system 50 that employs a base unit 52 for controlling the operation of the system 50. In other contexts, the switching units 55a-h may be employed in other types of lighting system, such as mesh lighting systems that do not use a centralized base unit. As an example, if any switching unit 55a-h receives an input affecting the operational state of a remote load controlled by another switching unit 55a-h, the switching units 55a-h may communicate among one another to effectuate the desired state. In such an embodiment, a command for changing an operational state of a local load for one switching unit 55a-h may originate and/or be received from another switching unit 55a-h.

1. A lighting system, comprising:
a base unit; and
a plurality of switching units including a first switching unit and a second switching unit, the plurality of switching units respectively coupled to a plurality of light sources including a first light source and a second light source, each of the switching units configured to control at least a respective one of the light sources based on commands received from the base unit, the first switching unit having a plurality of user input devices including a first user input device and a second user input device, the first switching unit configured to control an operational state of the first light source based on inputs received via the first user input device independent of communication with the base unit, the first switching unit further configured to transmit, to the base unit, input messages indicative of inputs received via the second user input device.

2. The system of claim 1, wherein the first switching unit is configured to transmit, to the base unit, a state update message indicative of the operational state of the first light source after changing the operational state based on an input received via the first user input device.

3. The system of claim 1, wherein the first switching unit is configured to transmit a first input message in response to a user input that activates the second user input device, the first input message indicating whether the second user input device remains continuously activated, in response to the user input, for longer than a specified time period.

4. The system of claim 3, wherein, if the second user input device remains continuously activated, in response to the user input, for a duration longer than the specified time period, the first switching unit is configured to transmit a second input message indicating when the second user input device is no longer activated.

5. The system of claim 4, wherein the base unit is configured to control an operational state of the second light source based on an amount of time between the first and second input messages.

6. The system of claim 4, wherein the base unit is configured to control an operational state of the second light source based on a length of the duration.

7. The system of claim 6, wherein the second user input device comprises a button.

8. The system of claim 6, wherein the first switching unit is configured to transmit, to the base unit, a state update message indicative of the operational state of the first light source after changing the operational state based on an input received via the first user input device.

9. A lighting system, comprising:
a remote unit; and
a switching unit coupled to a light source and having at least one user input device and a wireless transceiver, the switching unit configured to receive, via the wireless transceiver, a command from the remote unit and to control the light source based on the command, the switching unit further configured to control the light source in response to a user input received via the at least one user input device independent of communication with any remote unit of the lighting system via the wireless transceiver, the switching unit further configured to transmit, via the wireless transceiver, input messages indicative of inputs received via the at least one user input device.

10. The system of claim 9, wherein the remote unit is a base unit.

11. The system of claim 9, wherein the remote unit is a switching unit.

12. The system of claim 9, wherein the switching unit is configured to transmit, to the remote unit, a state update message indicative of an operational state of the light source after controlling the light source based on an input received via the at least one user input device.

13. The system of claim 9, wherein the switching unit is configured to make a determination as to whether the at least one user input device remains activated via a user input for longer than a specified time period, the switching unit further configured to transmit an input message to the remote unit based on the determination.

14. The system of claim 13, wherein the switching unit, based on the determination, is configured to transmit another input message to the remote unit in response to a determination that the at least one user input device is no longer activated.

15. The system of claim 14, wherein the remote unit is configured to control an operational state of at least one load based on the input messages and an amount of time that the at least one user input device remains continuously activated.

16. The system of claim 9, wherein the switching unit is configured to transmit, to the remote unit, a state update message indicative of an operational state of the light source in response to the user input received via the at least one user input device.

17. The system of claim 9, wherein the switching unit is configured to determine a value indicative of the amount of time that the at least one user input device remains activated in receiving the user input, the switching unit further configured to control the light source based on the value.

18. A method for use in a lighting system, comprising the steps of:
receiving a command from a base unit via a wireless transceiver;
controlling a light source based on the command;
receiving a user input via at least one user input device;
controlling the light source based on the user input independent of communication via the wireless transceiver; and
transmitting, via the wireless transceiver to the base unit, messages indicative of inputs received via the at least one user input device.

19. The method of claim 18, further comprising the step of transmitting, to the base unit, a state update message indicative of an operational state of the light source as affected by the user input.

20. The method of claim 18, further comprising the steps of:
determining whether the at least one user input device is activated during the receiving step for longer than a specified time period; and
transmitting an input message to the base unit based on the determining step.

21. The method of claim 18, further comprising the step of transmitting, to the base unit, a state update message indicative of an operational state of the light source in response to the user input.

22. The method of claim 18, further comprising the step of determining whether the at least one user input device is activated during the receiving step for longer than a specified time period, wherein the controlling the light source based on the user input step is based on the determining step.
